(19) United States
(12) Patent Application Publication
(10) Pub. No.: US 2005/0212880 A1
(43) Pub. Date: Sep. 29, 2005

(54) Ink cartridge for mounting onto a recording head

(75) Inventor: Markus Lehner, Arnstorf (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: KMP PRINT TECHNIK AG

(21) Appl. No.: 11/119,978

(22) Filed: May 2, 2005

Related U.S. Application Data
(63) Continuation of application No. PCT/EP03/12093, filed on Oct. 30, 2003.

(30) Foreign Application Priority Data
Oct. 30, 2002 (DE) 102 50 610.8

(51) Int. Cl. B41J 2/175

(52) U.S. Cl. 347/86

(57) ABSTRACT

An ink cartridge for fitting onto a recording head of the type having an ink feed needle, comprising a first ink chamber which contains a first porous and compressible element, and an ink feed nozzle connected to the first ink chamber via at least one passage opening, for the purpose of channelling the ink out of the first ink chamber to the ink feed needle. The ink feed nozzle contains a second porous and compressible element which is engaged by the needle and which is movably arranged in the ink feed nozzle so as to press against the first porous and compressible element when the second element is engaged by the needle.

### CROSS REFERENCE TO RELATED APPLICATION

The present application is a continuation of international application PCT/EP03/12093, filed 30 Oct., 2003, and which designates the U.S. The disclosure of the referenced application is incorporated herein by reference.

### BACKGROUND OF THE INVENTION

The present invention relates to an ink cartridge that is fitted onto a recording head, preferably onto a recording head for an ink jet printer. The recording head exhibits at least one ink feed needle by which the ink is transported from the ink cartridge to the recording head. The ink cartridge according to the invention is distinguished in that it exhibits at least one ink feed nozzle which is molded on an ink chamber serving as an ink reservoir and containing at least one element made of a porous and compressible material and which is connected to the ink chamber via a passage opening. The ink feed nozzle contains at least one element that is movably arranged within the ink feed nozzle and made of a porous and compressible material.

DE 695 14 060 T2 discloses an ink cassette for an ink jet printer, said ink cassette exhibiting a through hole leading to an ink feed opening through which an ink feed needle is introduced. In the direction towards a foam chamber, which serves as ink reservoir, the through hole is provided with a filter which is fixed to the upper side of the through hole facing towards the foam chamber. Both the region of the ink feed opening and the region of the through hole are of completely hollow design. The ink feed nozzle which is formed by the ink feed opening and the through hole projects into the interior of the foam chamber. The hollow ink feed nozzle, however, often gives rise to a high content of air in this region, which can result in the formation of air pockets. Such air pockets, however, may prevent reliable initial use of the cartridge. Furthermore, in the event of relatively long storage of an ink cartridge that has been designed in such a manner, deposits may arise in the region of the side walls of the ink feed nozzle if pigmented inks or inks that have not been subjected to ultrafiltration are employed.

DE 692 27 441 T2 discloses an ink store cartridge which exhibits an ink supply port, said ink cartridge being provided with an opening on which a filter made of a high polymer or of a corrosion resistant metal is attached by welding. The ink supply port projects into the interior of an ink chamber and in this way elastically compresses a porous element in said ink chamber. The ink supply port as such is of hollow design.

U.S. Pat. No. 5,748,088 describes an ink cartridge exhibiting an ink feed nozzle which contains an ink conducting element that on one side is in pressure contact with an ink inlet portion and that with its other end is in pressure contact with an ink absorbing element, whereby the ink inlet portion does not take the form of an ink conducting needle. This ink conducting element is configured as a bundle of fibres with two different regions: an inner region having good ink conducting properties being surrounded by an outer region that exhibits inferior properties in this regard and that is formed by applying a binder onto the fibres. The direction of flow of the ink from the ink chamber to the recording head in this case is predetermined by the orientation of the fibres in the fibre bundle. Moreover, in U.S. Pat. No. 5,748,088 it is described that, despite the pressure that is exerted by the ink inlet mechanism of the recording head on one end of the bundle of fibres, the bundle of fibres has to retain its shape and is not deformed or compressed, which is the reason why the configuration in the form of a rigid bundle of fibres is necessary. Since the fibres have to be tightly packed, which has to be effected either by a selective filling out of the interspace between the fibres or by pressure bonding or heat bonding of the fibres to one another, this ink conducting element is accessible only by means of a comparatively very elaborate manufacturing process.

One object of the present invention is to avoid the disadvantages exhibited by the structural designs pertaining to the state of the art as described above.

### SUMMARY OF THE INVENTION

The above and other objects and advantages of the present invention are achieved by the provision of an ink cartridge for mounting on a recording head which includes at least one ink feed needle, and which comprises
(a) a first ink chamber containing a first porous and compressible element, and
(b) an ink feed nozzle which is connected to the first ink chamber via at least one passage opening, for the purpose of channelling the ink out of the first ink chamber to the ink feed needle. The ink feed nozzle is configured so as to not project into the interior of the first ink chamber, and it contains a second porous and compressible element which is movably arranged in the ink feed nozzle.

Within the scope of the present text, the expression “first ink chamber” is understood to mean an ink chamber that contains a compressible porous element suitable for the uptake of ink. A “first ink chamber” according to the present invention also exhibits, in addition to a compressible porous element, at least one passage opening leading to an ink feed nozzle.

An ink cartridge according to the invention may, in principle, comprise one or more first ink chambers separated from one another, whereby in the case where the ink cartridge comprises two or more first ink chambers each first ink chamber is connected to a respective ink feed nozzle via one or more respective passage openings. Each first ink chamber is preferably connected to an ink feed nozzle via one passage opening. Each first ink chamber may, in principle, have a volume differing from that of the other first ink chambers, or may have a variable geometry. The first ink chambers in this case each contain at least one compressible porous element, the pores of which are filled with ink when the ink cartridge is charged.

In addition to at least one first ink chamber, an ink cartridge according to the invention may also exhibit at least one or more further ink chambers, for example a second ink chamber or, for example, a second and a third ink chamber. The further ink chambers in this case exhibit at least one passage opening leading to the preceding ink chamber, which in each instance is situated in the direction of the first ink chamber, so that all the ink chambers are in fluid communication with one another. For instance, an ink cartridge that comprises a first and a second ink chamber exhibits a passage opening between the first and second ink chambers. Within the scope of a preferred embodiment of the present invention, an ink cartridge according to the invention exhibits only one first ink chamber or a first and a second ink chamber. The further ink chambers may likewise contain a porous compressible element, but they do not have to. It is frequently advantageous if only the first ink chamber contains a porous compressible element and the second ink chamber or the further ink chambers do not contain a porous compressible element.

An ink cartridge according to the invention exhibits in the first ink chamber a passage opening that connects the first ink chamber to an ink feed nozzle which contains a movably arranged porous compressible element.

Whereas, within the scope of the present invention, it is possible that only one of several ink feed nozzles which are present in a cartridge exhibits a movably arranged porous and compressible element, in a preferred embodiment each of these ink feed nozzles contains a porous and compressible element.

Suitable in principle by way of porous and compressible element is any porous structural element that, under the conditions prevailing in the ink feed nozzle in the course of mounting the ink cartridge onto a recording head, is compressible in at least one spatial direction, preferably in the direction of the longitudinal axis of the ink feed nozzle directed towards the ink cartridge. Sponges made of polymeric materials, for example made of suitable polyurethanes, polyethers or polyesters and such like, are preferably employed by way of porous and compressible elements.

Suitable porous and compressible elements preferably exhibit a compressibility from approximately 2.5 to approximately 12, in particular from approximately 3 to approximately 5.

The pore size of suitable porous and compressible elements amounts to, for example, approximately 40 ppi to approximately 120 ppi, in particular 60 ppi to approximately 80 ppi (ppi=pores per inch).

Within the scope of the present invention the ink feed nozzle may be substantially freely adapted in accordance with the demands that the recording head with ink feed needle makes upon the geometry of the ink feed nozzle. For instance, it is conceivable that the ink feed nozzle exhibits an outer cross section having a rectangular, square, round or substantially circular shape, while the interior of the ink feed nozzle exhibits, independently of the outer cross section, a rectangular, square, round or substantially circular cross section.

The ink feed nozzle preferably exhibits an inner cross section and an outer cross section that are both substantially circular. Both the inner diameter and the outer diameter of the ink feed nozzle may get larger or smaller in the direction of the recording head, or may get larger or smaller intermittently, or may exhibit differing sizes intermittently. Preferably both the inner diameter and the outer diameter of the ink feed nozzle are constant along the longitudinal axis of the ink feed nozzle, and the ink feed nozzle accordingly takes the form of a hollow cylinder.

The ink feed nozzle may, in principle, be produced from a material or materials other than those of the respective ink chambers, and may be attached in suitable manner onto the first ink chamber in the given case. The ink chamber and the ink feed nozzle are preferably produced from the same material or materials and are formed together in one piece.

In principle, it is conceivable that the ink feed nozzle projects into the interior of the ink chamber. The inner and/or outer geometry of that part of the ink feed nozzle which projects into the ink chamber may be identical to or different from the inner and/or outer geometry of the part of the ink feed nozzle located on the outside of the ink chamber. In a particularly preferred embodiment, however, the ink feed nozzle does not project into the interior of the ink chamber but terminates flush with the bottom of the ink chamber.

The present invention accordingly relates to an ink cartridge, as described above, which is characterised in that the ink feed nozzle according to (b) terminates flush with the interior of the ink chamber according to (a).

According to the invention, the ink feed nozzle contains a porous and compressible element that is movably arranged in the ink feed nozzle. In this connection it is not necessary that said porous element is located totally within the ink feed nozzle. Rather, it is also possible that only a part of the porous element is located in the ink feed nozzle. Similarly, it is possible that prior to the fitting of the ink cartridge onto the ink feed needle the porous element is located totally within the ink feed nozzle, whereas after the mounting only a part of the porous element is enclosed by the ink feed nozzle.

In principle, the ink feed nozzle may contain, in addition to the porous, compressible and movably arranged element, one or more further ink conducting elements that are designed to be porous and/or compressible or to be ink conducting in some other way. Should two or more porous and compressible elements be contained in the ink feed nozzle, each of these elements may have a variable geometry, depending on the geometry of the ink feed nozzle. The ink chamber according to the invention preferably contains a single porous, compressible and preferably movably arranged element.

In a preferred embodiment of the present invention, according to which the ink feed nozzle is of hollow cylindrical design, in particularly preferable manner the porous element in the ink feed nozzle also has a cylindrical shape. For example, the diameter of the porous element is chosen so that the porous element fills out the ink feed nozzle and touches the inner surface of the ink feed nozzle substantially over its full extent, whereby, however, the mobility of the porous element within the ink feed nozzle should be guaranteed. However, according to the invention there is provision similarly that the porous element does not fill out the ink feed nozzle completely and touches the inner surface of the ink feed nozzle only partially or not at all.

The ink cartridge according to the invention is suitable for mounting on recording heads that exhibit one ink feed needle. The expression “ink feed needle” in this connection is understood to mean a structural element of the recording head that provides for the channelling of ink out of the ink cartridge into the recording head. An ink feed needle such as is required within the scope of the present invention for an ink cartridge according to the invention has a diameter that is smaller than the diameter of the ink feed nozzle of the ink cartridge. The diameter of a suitable ink feed needle preferably amounts to approximately 0.99 times to 0.01 times, for example 0.9 times to 0.02 times or 0.8 times to 0.05 times or 0.5 times to 0.1 times, the diameter of the ink feed nozzle.

The porous element in the ink feed nozzle is of such geometry that after the ink cartridge has been fitted on the recording head one end of it is in pressure contact with the first porous element of the first ink chamber, and the other end of it is in pressure contact with the ink feed needle. In this connection the porous element in the ink feed nozzle may already be located in contact with the porous element of the first ink chamber prior to the fitting of the ink cartridge onto the ink feed needle, or may only be brought into pressure contact with the porous element of the first ink chamber by virtue of the pressure exerted by the ink feed needle on the porous element in the ink feed nozzle.

Should two or more porous elements be contained in one ink feed nozzle, said porous elements are of such geometry that, after the ink cartridge has been mounted onto the ink feed needle, on the one hand they are in pressure contact with one another, and on the other hand at least one of the porous elements is in pressure contact with the ink feed needle, another of the porous elements is in pressure contact with the porous element of the first ink chamber, and in this way the flow of ink from the first ink chamber to the ink feed needle can be established.

Accordingly, the present invention also relates to an ink cartridge, as described above, which is characterised in that after the ink cartridge has been fitted on the recording head the at least one second porous element is in pressure contact with the at least one first porous element in the ink chamber and is in pressure contact with the ink feed needle.

If in an ink cartridge the first and further ink chambers should be charged with different ink in each instance, for example with ink of a different color, the materials from which the respective porous elements in the respective ink feed nozzles are produced may also be different from one another. Differences may consist, for example, in the material itself or, for example, in the pore size. In this connection it merely has to be guaranteed that in the event of pressure contact between the ink feed needle and the porous element of the ink feed nozzle and between the porous element of the ink feed nozzle and the porous element of the ink chamber a sufficient flow of ink can be established from the porous element of the ink chamber to the porous element of the ink feed nozzle and from the latter to the ink feed needle.

The ink feed needle may, in principle, have substantially any shape, provided that the above limits of the diameter are still respected. In this connection the tip of the ink feed needle may, for example, be substantially of cylindrical, conically tapering design or may take the form of a hemispherical shell and exhibit one or more openings for the up take of ink. A suitable ink feed needle is, for example, formed in such a way that it exhibits a conically tapering end and, in the face at the tip, exhibits a plurality of through holes which in the event of pressure contact of the ink feed needle with the porous element come into contact with the ink filled pores of the porous element and enable the ink to flow into an ink conducting duct which is formed in the interior of the ink feed needle.

The passage opening that connects the ink feed nozzle to the ink chamber is preferably formed in such a way that its geometry matches the inner geometry of the ink feed nozzle. In the case of cylindrical geometry of the ink feed nozzle this passage opening is therefore substantially circular and has a diameter that matches the inside diameter of the nozzle and permits the passage of the porous element of the ink feed nozzle into the ink chamber.

If in the course of fitting the ink cartridge on the recording head the ink feed needle comes into pressure contact with the porous element within the ink feed nozzle, the porous element is elastically deformed and the capillary forces that arise in the deformed region of the porous element bring about a preferential direction for the flow of ink, which conducts the ink into the deformed region and hence precisely to the tip of the ink feed needle, which is provided with the passage holes.

In a particularly preferred embodiment of the present invention, according to which the ink feed nozzle contains a single porous element, as a result of the generation of the pressure contact by means of the ink feed needle the porous element which is movably arranged is not only deformed by the tip of the needle but is also displaced in the direction of the first ink chamber, as a result of which a pressure contact is established between the porous element of the ink feed nozzle and the porous element contained in the ink chamber. In this connection the region in which the porous element of the ink chamber is brought into pressure contact with the porous element of the ink feed nozzle is deformed in such a way that by virtue of the capillary forces arising in the porous and compressible materials a preferential direction of the flow of ink from the porous element of the ink chamber towards the porous element of the ink feed nozzle is brought about.

In a preferred embodiment of the present invention, the at least one porous element which is movably arranged in the ink feed nozzle exhibits a lower compressibility than the at least one porous element of the ink chamber. As a result, it is guaranteed that the pores of the porous element of the ink chamber are made smaller precisely in the region in which the porous element of the ink feed nozzle is in pressure contact with the porous element of the ink chamber, and the capillary forces described above arise in precisely this region. Thus the flow of ink from the ink chamber into the ink feed nozzle is induced efficiently by the pressure contact of two porous and differently compressible elements.

The present invention therefore also relates quite generally to the use of two porous elements, the ink being stored in one of the porous elements, and said ink being conducted to an ink feed needle via the other porous element. In this connection, as already described above, the two porous elements are in pressure contact with one another. The porous element in which the ink is stored exhibits a greater compressibility than the porous element via which the ink is conducted to the ink feed needle. The latter element is again in pressure contact with the ink feed needle in the course of channelling of the ink.

Accordingly, the present invention also relates to the use of two porous elements of differing compressibility for the purpose of supplying ink out of the porous element of greater compressibility via the porous element of lower compressibility to an ink feed needle of a recording head. The ink feed needle is in pressure contact with the porous element of lower compressibility.

The material from which the porous element in the ink chamber is produced may be substantially freely chosen and has only to satisfy the requirements described above. Porous, compressible materials are preferably employed that correspond substantially to those already described within the scope of the description of the porous and compressible element in the ink feed nozzle. However, the compressible element in the ink feed nozzle preferably exhibits a lower compressibility or a smaller pore size or both.

Accordingly, the present invention also relates to an ink cartridge, as described above, which is characterised in that the at least one second porous element exhibits a lower compressibility than the at least one first porous element. Similarly, the present invention accordingly also relates to a process for channelling ink out of an ink cartridge comprising
(a) at least one first ink chamber by way of ink reservoir, containing a compressible first porous element, and
(b) an ink feed nozzle which is connected to the first ink chamber via a passage opening, containing a movably arranged, compressible second porous element to a recording head, comprising the following steps:
(i) mounting the ink cartridge on a recording head;
(ii) generating a pressure contact between the ink feed needle of the recording head and the porous element of the ink feed nozzle by virtue of the mounting according to (i);
(iii) displacing the porous element of the ink feed nozzle by virtue of pressure contact according to (ii) in the direction of the porous element of the ink chamber;
(iv) generating a pressure contact between the porous element of the ink feed nozzle and the porous element of the ink chamber by virtue of the displacement according to (iii).

By virtue of the movable arrangement of the porous and compressible element in the ink feed nozzle, moreover a cleaning of the inner wall of the ink feed nozzle is obtained. As a result of fitting the ink cartridge on the ink feed needle, the porous element in the ink feed nozzle, which at least partially touches the inside of said nozzle, is moved in the direction of the ink chamber, whereby the outside of the porous element wipes the inside of the ink feed nozzle. Since the outside of the porous element also exhibits pores, ink that is adhering to the inside of the ink feed nozzle will be taken up into the porous element and can be supplied to the ink feed needle.

A fundamental advantage that the ink cartridge according to the invention offers is the combined action of the porous element in the ink feed nozzle. On the one hand, by virtue of the pressure contacts that have been established in the course of the fitting on the ink feed needle, the porous element enables the accurately directed flow of ink, induced by capillary effects, from the ink feed chamber to the ink feed needle. In addition to this, there is the effect of cleaning the inside of the ink feed nozzle. Similarly, the filter action which makes the fixed and therefore elaborate fitting of a filter superfluous is to be emphasised. Moreover, by virtue of the total porous structure extending as far as the marginal regions of the element, residual ink is conducted out of precisely these marginal regions to the ink feed needle. The porous element in the ink feed nozzle is accordingly a multifunctional element which, with an extremely simple form of construction, combines in itself the most diverse merits.

In a further preferred embodiment, the ink feed nozzle contains, at the end facing to wards the recording head, a packing element that is adapted to the geometry of the ink feed nozzle. According to a preferred embodiment, in which the inner geometry of the ink feed nozzle is cylindrical, the packing element is therefore likewise of substantially cylindrical design, the diameter of the packing element being chosen so that the sealing of the ink feed nozzle being striven for in relation to the recording head is obtained.

Since in the course of mounting the ink cartridge onto the ink feed needle the latter has to be brought into pressure contact with the porous element of the ink feed nozzle, the packing element exhibits a recess, by virtue of which the ink feed needle can be introduced into the nozzle. This recess can be adapted to the geometry of the ink feed needle. Similarly, it is conceivable to choose the material of the packing ring so that the packing element adapts itself, by reason of its flexibility, to the geometry of the needle and in this way guarantees the requisite sealing.

Prior to the mounting of the ink cartridge onto the ink feed needle the recess described above can be closed in suitable manner, for example by means of a thin film, and can be pierced by the ink feed needle in the course of mounting onto the recording head.

In the case of an ink feed needle having an outer geometry that is substantially circular, in particularly preferred manner the recess of the packing element is of circular design. The diameter of the circular recess is preferably chosen so that it is slightly smaller than the outer diameter of the ink feed needle and in this way brings about an effective sealing of the interior of the ink cartridge in relation to the environment. The sealing of the interior of the ink cartridge is therefore preferably brought about via a packing element which rests in close contact with the outside of the ink feed needle.

In this connection it is possible, within the scope of the present invention, for the aforementioned packing element to be supplemented by one or more further packing elements. Such further packing elements may be located, for example, at the end of the ink feed nozzle directed towards the recording head, or on the recording head itself.

Accordingly, the present invention also relates to an ink cartridge, as described above, which is characterised in that the ink feed nozzle exhibits a packing element at its end facing towards the recording head.

In a further preferred embodiment, the substantially circular recess in the annular packing element is designed in such a way that it tapers conically from its side facing towards the recording head, the smallest diameter of the hole obtained by virtue of the tapering, as described above, being slightly smaller than the outer diameter of the ink feed needle. In addition to the aspect constituted by the saving of material, a guidance of the ink feed needle through the packing element is obtained by this means.

In a further preferred embodiment of the ink cartridge according to the invention, the packing element and the porous element of the ink feed nozzle are spatially separated from one another, as a result of which the direct contact between the two elements is prevented and a displacement of the packing element in the course of introducing the ink feed needle in the direction of the first ink chamber is prohibited. In a preferred embodiment this spatial separation is obtained by means of at least one retaining element which is arranged between the packing element and the porous element.

The design of the retaining element is generally not subject to any restrictions. Only the spatial separation that has been described has to be realised, and furthermore it has to be made possible for the ink feed needle to be brought through the packing element and the separating element into pressure contact with the porous element of the ink feed nozzle.

The ink cartridge according to the invention in the ink feed nozzle preferably exhibits a single retaining element which is of annular design.

Accordingly, the present invention also relates to an ink cartridge, as described above, which is characterised in that the annular packing element is spatially separated from the second porous element by means of at least one retaining element which is molded on the inside of the ink feed nozzle.

In principle, the ink cartridge according to the invention comprises both embodiments according to which the porous element in the ink feed nozzle is already in pressure contact with the porous element of the ink chamber prior to mounting of the cartridge onto the ink feed needle, and embodiments in which the pressure contact between the porous element of the ink feed nozzle and the porous element of the ink chamber is brought about only by the mounting of the cartridge onto the ink feed needle. The first embodiment here is obtained, for example, in such a way that the porous element in the ink feed nozzle is longer than the spacing between the separating ridge in the ink feed nozzle and the porous element in the ink chamber.

The second embodiment may be formed by the length of the porous element in the ink feed nozzle being less than or equal to the spacing between the separating ridge and the porous element of the ink chamber but being chosen to be so great that by virtue of the contact between the ink feed needle and the porous element the latter is brought into pressure contact with the porous element of the ink chamber. In this second embodiment it is conceivable, for example, to choose the length of the porous element as a function of the length of that part of the ink feed needle which, after mounting of the ink cartridge onto the ink feed needle, projects into the interior of the ink feed nozzle, so that the flow of ink described above, generated by capillary forces, from the porous element of the ink chamber to the porous element of the ink feed nozzle only begins when the ink feed needle is brought into pressure contact with the porous element of the ink feed nozzle by mounting of the cartridge, thereby the porous element of the ink feed nozzle is pushed in the direction of the porous element of the ink chamber by the ink feed needle and hence is brought into pressure contact with said porous element.

Within the scope of the present invention the interior of the ink chamber may be formed in substantially arbitrary manner.

In a preferred embodiment, the bottom of the ink chamber, on which the ink feed nozzle is molded and connected to the ink chamber via the passage opening, is formed at least partially in non planar manner. By virtue of, for example, convex, trough shaped configuration of the bottom it is ensured, inter alia, that the ink has a tendency to collect more easily in the middle of the bottom of the ink chamber and is therefore located closer to the passage opening leading to the ink feed nozzle. Particularly in the case of a stock of ink in the ink chamber that is running out, ink that would otherwise collect at the outer edges in the interior of the ink chambers and would constitute unusable residual ink is avoided.

Accordingly, the present invention also relates to an ink cartridge, as described above, which is characterised in that the bottom of the ink chamber is of trough shaped design.

The porous element in the ink chamber can be adapted in its geometry to the non planar bottom of the ink chamber. In the case of a convex bottom of the ink chamber, a porous element is therefore capable of being employed that is formed in concave manner on its underside facing towards the bottom of the ink chamber.

The ink chamber is provided on its open upper side, which is preferably located opposite the passage opening, with a detachably or non detachably fitted closure element. This closure element is preferably designed in such a way that it seals the edges of the side walls of the ink chamber with regard to the outflow of ink from the ink chamber.

At least one reinforcing element may, for example, be molded onto the underside of the closure element facing towards the ink chamber.

In the case where the ink cartridge comprises two or more first ink chambers, use is preferably made of a single closure element which seals all the ink chambers at the same time.

The closure element (cover) of an ink cartridge according to the invention exhibits one or more vent openings which enable an exchange of gas and/or material with the environment. In the course of delivery of the ink cartridge to intermediaries or to final users, each of the vent openings of the closure element may be closed with, in each in stance, at least one sealing element.

In this connection the sealing element may, for example, be an element fitted to the out side of the closure element. The sealing element is preferably fitted externally on the respective opening, in order that it can be easily removed by the final user prior to initial operation of the ink cartridge.

The ink cartridge according to the invention preferably further exhibits at least one abutment element which is molded on the underside of the bottom of the ink chamber facing towards the recording head. This abutment element is used, inter alia, for the purpose of guaranteeing as advantageous an abutment as possible of the ink cartridge on the recording head. The geometry of the abutment surface of the at least one abutment element is accordingly capable of being adapted to the requirements of the most diverse recording heads. Since the abutment against the recording head is thereby realised substantially via the abutment element, the bottom of the ink chamber is capable of being configured in highly variable manner. If the ink cartridge comprises two or more first ink chambers, each of the ink chamber bottoms may exhibit a molded on abutment element, in which case the individual abutment elements may be identical to or different from one another. In a preferred embodiment, each bottom of a first ink chamber exhibits a separate abutment element, the abutment elements being, moreover, preferably of identical design.

The materials from which the ink cartridge and the closure element are produced are substantially not subject to any restrictions. For instance, it is possible to manufacture the ink cartridge and/or the at least one closure element from a transparent material, thus allowing an optical check of the filling level of the cartridge when the cartridge is removed from the recording head. Of course, the ink cartridge and the closure element may consist of different materials.

In a quite particularly preferred embodiment, the ink cartridge is formed in one piece, and only the at least one closure element, the porous elements in the ink chamber and in the ink feed nozzle, as well as the packing element that seals the ink feed nozzle in relation to the recording head are included as separate elements.

In the course of delivery of the ink cartridge according to the invention which has been charged with ink, said ink cartridge comprises, in addition to the sealing element which is fitted to the closure element, at least one further sealing element which is fastened to a lower edge of the ink feed nozzle facing towards the recording head.

Preferred, in accordance with the invention, are ink cartridges having one first ink chamber and ink cartridges having three or four first ink chambers and, optionally in addition to a first ink chamber in the given case, one or more further ink chambers, as described above. If the ink cartridge contains, for example, three first ink chambers, the latter are preferably charged with three inks of different colors, such as, for example, inks of the colors cyan, magenta and yellow.

### BRIEF DESCRIPTION OF THE DRAWINGS

The invention will be described in more detail in conjunction with the following drawings of exemplary embodiments, in which:

FIG. 1 is a perspective view of an ink cartridge which embodies the invention, with parts broken away to show the interior of the ink feed nozzle;

FIG. 2 is a vertical section view of the cartridge shown in FIG. 1;

FIG. 3 is a view similar to FIG. 2 and illustrating an embodiment wherein the porous and compressible elements of the ink chamber and nozzle are initially in contact;

FIG. 4 is a view similar to FIG. 2 and illustrating an embodiment wherein the porous and compressible element of the nozzle has been moved toward the ink chamber by the needle;

FIG. 5 shows an embodiment which includes three ink chambers, each with an associated nozzle;

FIG. 6 is a perspective view of a packaging rink which may be used with the ink cartridge of the invention; and

FIG. 7 is a sectional view of the packaging ring shown in FIG. 6.

### DETAILED DESCRIPTION OF THE PREFERRED EMBODIMENTS

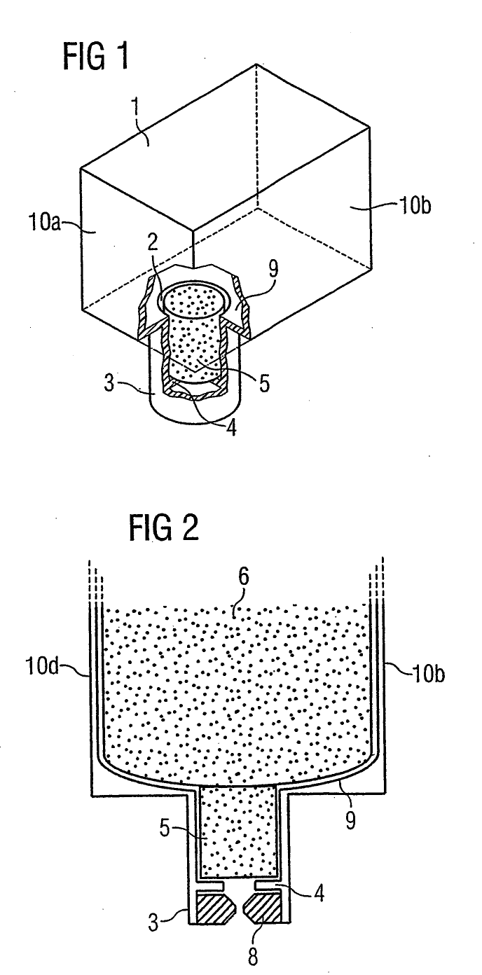

Referring more particularly to the drawings, FIG. 1 shows an ink cartridge according to the invention with an ink chamber 1 with side walls 10a and 10b, with a circular passage opening 2 on the ink chamber bottom 9, with a hollow cylindrical ink feed nozzle 3 molded on the ink chamber bottom 9, which exhibits an annular retaining element 4 and also a movably arranged porous and compressible element 5, the length of which corresponds to the spacing between the upper side of the retaining element 4 facing towards the ink chamber and the ink chamber bottom 9.

FIG. 2 shows a section through an ink cartridge according to the invention according to FIG. 1 with the side walls 10b and 10d, the ink chamber bottom 9 being of trough shaped design. The porous and compressible element 6 in the ink chamber 1 is shown in this representation. According to this embodiment, in which the length of the porous and compressible element 5 corresponds to the spacing between the upper side of the retaining element 4 facing towards the ink chamber 1 and the ink chamber bottom 9, there is no pressure contact as yet between the elements 5 and 6 prior to the mounting of the ink cartridge onto an ink feed needle. Below the retaining element 4 a packing element 8 in the form of a ring can be seen which seals the ink feed nozzle 3 in relation to an ink feed needle (not represented).

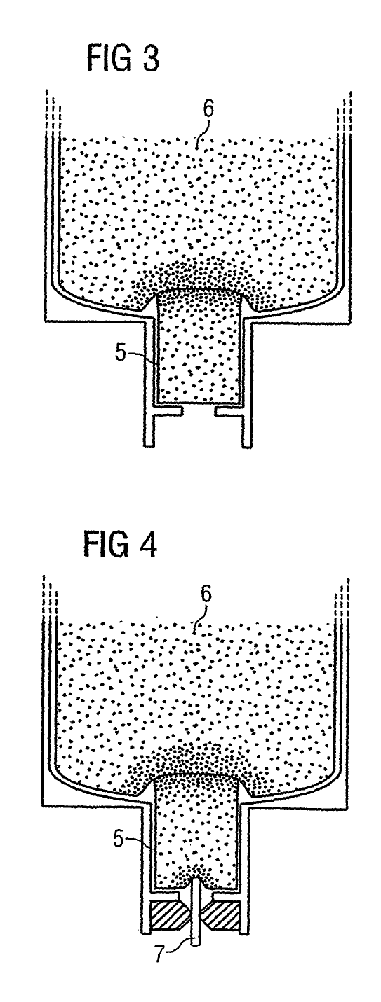

FIG. 3 shows a further embodiment in which the movably arranged porous and compressible element 5 is already in pressure contact with the porous element 6 in the ink chamber prior to the mounting of the ink cartridge onto an ink feed needle, since the length of the element 5 is greater than the spacing between the upper side of the separating ridge 4 facing towards the ink chamber 1 and the ink chamber bottom 9, and the element 5 consequently projects through the passage opening 2 into the ink chamber 1.

FIG. 4 shows the embodiment according to FIG. 2, the ink cartridge in FIG. 4 being represented after mounting onto an ink feed needle 7 of a recording head (not represented). As a result of the mounting of the ink cartridge onto the ink feed needle 7, the porous element 5 is, on the one hand, compressed on its underside facing towards the ink feed needle 7 and, on the other hand, pushed in the direction of the ink chamber 1 by the pressure exerted by the ink feed needle 7. In the process, a pressure contact is established between the porous element 5 of the ink feed nozzle and the porous element 6 of the ink chamber 1, and porous element 6, which is more compressible than porous element 5, is compressed. As a result of the reduction in size of the pores in the respective compressed regions of the porous elements 5 and 6, a preferential direction of flow of the ink from the ink chamber 1 to the ink feed needle 7 is consequently formed.

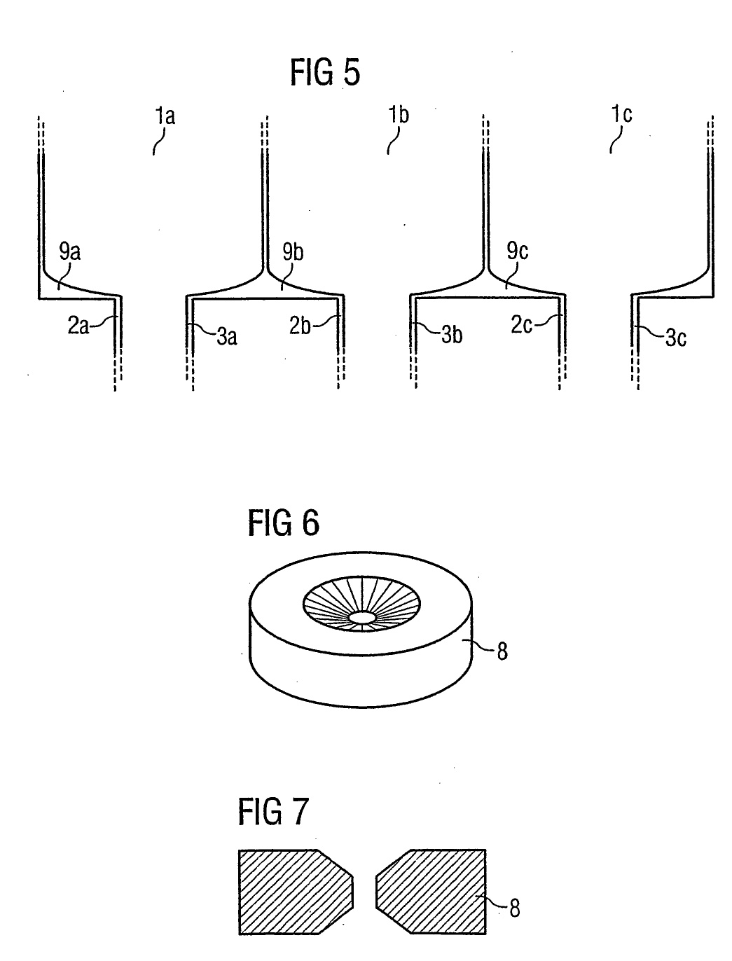

FIG. 5 shows an embodiment of the ink cartridge according to the invention with three ink chambers 1a, 1b and 1c with circular passage openings 2a, 2b and 2c, with three hollow cylindrical ink feed nozzles 3a, 3b and 3c, and also with the ink chamber bottoms 9a, 9b and 9c of trough shaped design in each ink chamber 1a, 1b and 1c. FIG. 5 therefore shows a structural example of an embodiment according to the present invention comprising several first ink chambers.

FIGS. 6 and 7 show a preferred embodiment of a packing ring 8. From these views it becomes clear how the hole in the packing ring 8 tapers conically, in order in the course of fitting the ink cartridge onto the ink feed needle 7 to provide a guide for said needle.

Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An ink cartridge for mounting on a recording head which includes an ink feed needle, comprising
a first ink chamber which defines an ink reservoir, with a first porous and compressible element contained in the chamber,
an ink feed nozzle connected to the first ink chamber via at least one passage opening for channeling the ink out of the first ink chamber to the ink feed needle, and with the ink feed nozzle being configured to not project into the interior of the first ink chamber, and
a second porous and compressible element contained in the ink feed nozzle so as to permit movement of the second element toward the first ink chamber.

2. The ink cartridge according to claim 1, wherein after fitting of the ink cartridge on the ink feed needle the second porous element is in pressure contact with the first porous element in the first ink chamber and in pressure contact with the ink feed needle.

3. The ink cartridge according to claim 2, wherein the second porous element exhibits a lower compressibility than the first porous element.

4. The ink cartridge according to claim 1, wherein the ink feed nozzle mounts an annular packing element at its end facing towards the recording head.

5. The ink cartridge according to claim 4, wherein the annular packing element is spatially separated from the second porous element by means of at least one retaining element which is molded on the inside of the ink feed nozzle.

6. The ink cartridge according to claim 1, wherein the first ink chamber has a bottom to which the ink feed nozzle is connected, and wherein the bottom has a trough shaped configuration.

7. The ink cartridge according to claim 1, wherein the first ink chamber includes an open upper side, and the first ink chamber further comprises a closure element closing the open upper side, with the closure element including at least one vent opening.

8. The ink cartridge according to claim 1, wherein the second porous and compressible element is configured to closely conform to and engage the internal wall of the ink feed nozzle about the entire periphery thereof, and so that the second porous and compressible element is moveable in a direction toward and into engagement with the first porous and compressible element while engaging the internal wall of the ink feed nozzle.

9. The ink cartridge according to claim 1 wherein the cartridge comprises a plurality of said first ink chambers, and a plurality of said ink feed nozzles which are connected to respective ones of said first ink chambers.

10. A method for delivering ink out of an ink cartridge, which comprises the steps of
providing an ink cartridge which comprises a first ink chamber which defines an ink reservoir, with a first porous and compressible element contained in the chamber, an ink feed nozzle connected to the first ink chamber via at least one passage opening for channeling the ink out of the first ink chamber into the ink feed nozzle, and with the ink feed nozzle being configured to not project into the interior of the first ink chamber, and a second porous and compressible element contained in the ink feed nozzle so as to permit movement therein in a direction toward the first ink chamber,
mounting the ink cartridge on a recording head which includes an ink feed needle, and including
(a) generating a pressure contact between the ink feed needle of the recording head and the second porous and compressible element in the ink feed nozzle,
(b) displacing the second porous and compressible element in the ink feed nozzle by virtue of pressure contact, with the displacement being in the direction toward the first porous and compressible element in the first ink chamber, and
(c) generating a pressure contact between the second porous element in the ink feed nozzle and the first porous element in the first ink chamber by virtue of the displacing step.

11. The method according to claim 10 wherein the second porous and compressible element is configured to engage the internal wall of the ink feed nozzle about the entire periphery thereof during the displacing step.
